(19) United States
(12) Patent Application Publication
(10) Pub. No.: US 2008/0057800 A1
(43) Pub. Date: Mar. 6, 2008

(54) ELASTIC METAL SHEET

(75) Inventors: XIAO-BO ZHANG, Shenzhen (CN); CHIA-TE YU, Tu-Cheng (TW); CHUNG-YUAN CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/770,759

(22) Filed: Jun. 29, 2007

(30) Foreign Application Priority Data
Sep. 1, 2006 (CN) 200620014505.4

(51) Int. Cl. H01R 4/10

(52) U.S. Cl. 439/878

(57) ABSTRACT

A kind of elastic metal sheet is disclosed. The elastic metal sheet includes a base, a bent portion, an elastic arm, and a contact portion. The base includes a first surface and an opposite second surface. The first surface is configured for connecting to a circuit substrate by soldering. The bent portion extends from an end of the base and is bent towards another end of the base. The elastic arm extends from an end of the bent portion. The contact portion extends from an end of the elastic arm and includes a contact surface distal from the base. The contact surface defines a dome-shaped bulge thereon. The dome-shaped bulge is configured for contacting an electronic component. The elastic metal sheet contacts the electronic component well even an elastic deformation occurs.

### BACKGROUND

1. Technical Field

The present invention relates to an elastic metal sheet, especially for an elastic metal sheet that is used as a connector.

2. General Background

Elastic metal sheet is usually used for connecting a circuit substrate and an electronic component. Referring to FIGS. 3 and 4, an elastic metal sheet 10′ usually includes a base 20′, an elastic arm 40′, and a contact portion 50′. The base 20′ is connected to a circuit substrate 70′ by soldering. The elastic arm 40′ extends upwardly from an end of the base 20′. The contact portion 50′ extends from an end of the elastic arm 40′ and includes a contact surface 500′ distal from the base 20′. The contact surface 500′ contacts an electronic component 60′ to provide an electrical connection. The electronic component 60′ pushes the contact portion 50′ to deform, as a result, the contact surface 500′ makes line contact with the electronic component 60′ at a border between the contact surface 500′ and the elastic arm 40′. The contact is weak because the force between the electronic component 60′ and the elastic metal sheet 10′ is little.

Therefore, what is needed is an elastic metal sheet that contacts well with the electronic component.

### SUMMARY

A kind of elastic metal sheet is disclosed. The elastic metal sheet includes a base, a bent portion, an elastic arm, and a contact portion. The base includes a first surface and an opposite second surface. The first surface is configured for connecting to a circuit substrate by soldering. The bent portion extends from an end of the base and is bent towards another end of the base. The elastic arm extends from an end of the bent portion. The contact portion extends from an end of the elastic arm and includes a contact surface distal from the base. The contact surface defines a dome-shaped bulge thereon. The dome-shaped bulge is configured for contacting an electronic component.

Further features and advantages will be provided or will become apparent in the course of the following detailed description.

### BRIEF DESCRIPTION OF THE DRAWINGS

FIG. 1 is a schematic, isometric view of an elastic metal sheet according to a preferred embodiment of the present invention;

FIG. 2 is a schematic, front view of the elastic metal sheet of FIG. 1 connected with a PCB and an electronic component;

FIG. 3 is a schematic, isometric view of an elastic metal sheet according to a related art; and

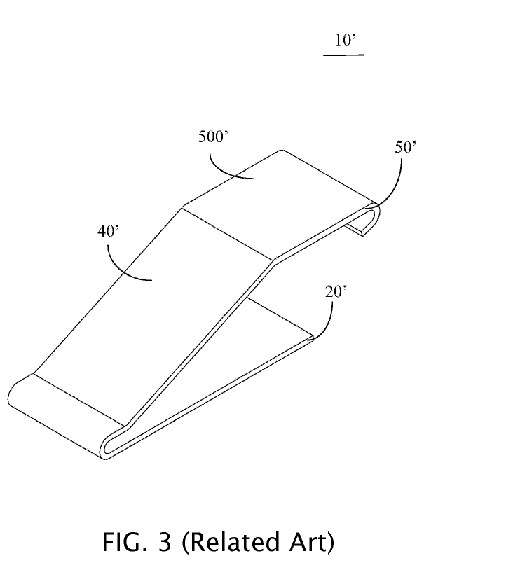

FIG. 4 is a schematic, front view of the elastic metal sheet of FIG. 3 connected with a PCB and an electronic component.

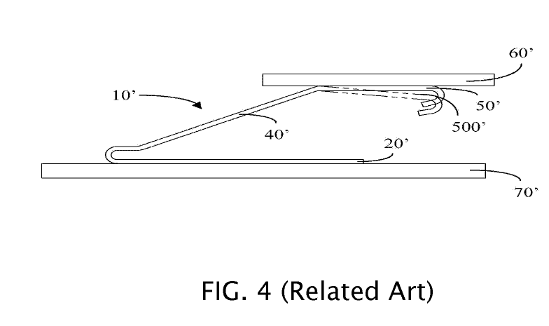

### DETAILED DESCRIPTION OF THE EMBODIMENT

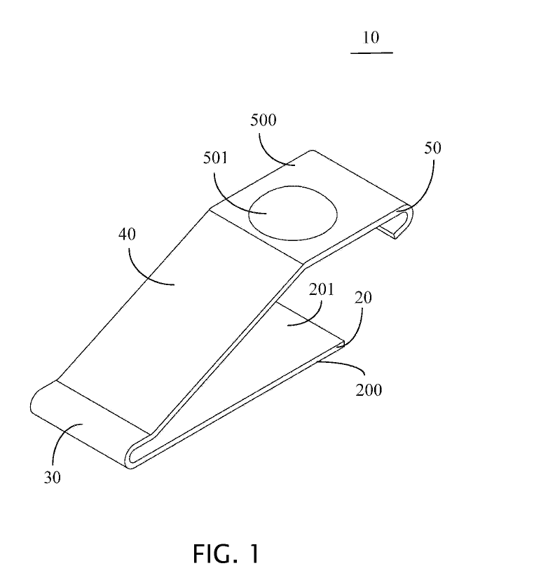

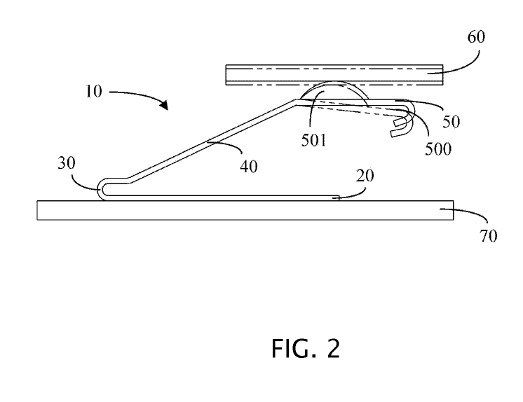

Referring to FIGS. 1 and 2, an elastic metal sheet according to a preferred embodiment of the present invention is disclosed. The elastic metal sheet 10 includes a base 20, a bent portion 30, an elastic arm 40, and a contact portion 50. The base 20 includes a first surface 200 and a second surface 201 opposite to the first surface 200. The first surface 200 is configured for connecting to a circuit substrate 70 by soldering. The bent portion 30 extends from an end of the base 20 and is bent towards another end of the base 20. An end of the bent portion 30 is parallel to the base 20. The elastic arm 40 extends obliquely and upwardly from the end of the bent portion 30. The contact portion 50 extends from an end of the elastic arm 40 and includes a contact surface 500 distal from the base 20. The contact surface 500 defines a dome-shaped bulge 501. The dome-shaped bulge 501 is positioned near the elastic arm 40.

The dome-shaped bulge 501 makes a point contact with an electronic component 60. As we all known, a point contact performs well than a line contact under little pressure. Thus the dome-shaped bulge 501 contacts the electronic component 60 well, even when elastic deformation occurs.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An elastic metal sheet comprising:
a base comprising a first surface and an opposite second surface, the first surface configured for connecting to a circuit substrate by soldering;
a bent portion extending from an end of the base and bent towards another end of the base;
an elastic arm extending from an end of the bent portion; and
a contact portion extending from an end of the elastic arm, comprising a contact surface distal from the base and a dome-shaped bulge which is formed on the contact surface, wherein the dome-shaped bulge is configured for contacting an electronic component.

2. The elastic metal sheet of claim 1, wherein the dome-shaped bulge is positioned near the elastic arm.

3. The elastic metal sheet of claim 1, wherein elastic arm extends obliquely upwardly.
